(19) United States
(12) Patent Application Publication
(10) Pub. No.: US 2026/0103428 A1
(43) Pub. Date: Apr. 16, 2026

(54) ASSEMBLY WITH DETACHABLE CONSTRUCTIONAL LAYER

(71) Applicant: SIKA TECHNOLOGY AG, Baar (CH)

(72) Inventors: Michael KRABLER, Thierhaupten (DE); Christina KRAEMER, Augsburg (DE); Thomas TAMCKE, Düsseldorf (DE)

(73) Assignee: SIKA TECHNOLOGY AG, Baar (CH)

(21) Appl. No.: 19/116,529

(22) PCT Filed: Dec. 18, 2023
(86) PCT No.: PCT/EP2023/025540

§ 371 Date: Mar. 28, 2025

(30) Foreign Application Priority Data
Dec. 16, 2022 (EP) 22214183.0

(51) Int. Cl. C04B 41/47; C04B 41/00; C04B 41/50; C04B 41/52; C04B 41/71; C09D 5/00; C09D 5/24; C09D 191/06; H05B 6/80

(52) U.S. Cl. CPC C04B 41/47; C04B 41/009; C04B 41/5076; C04B 41/52; C04B 41/71; C09D 5/002; C09D 5/24; C09D 191/06; H05B 6/80

(57) ABSTRACT

A layered assembly including a substrate based on a hydraulically binding composition, a primer layer, and a constructional layer wherein the primer layer is positioned between the substrate and the constructional layer, and wherein the primer layer includes a polymer and a wax. The invention also relates to methods for producing the layered assembly and methods for detaching the constructional layer from the layered assembly.

The invention relates to a layered assembly comprising a substrate based on a hydraulically binding composition, a primer layer and a constructional layer.

Subject of the invention is a layered assembly comprising
(a) a substrate based on a hydraulically binding composition,
(b) a primer layer, and
(c) a constructional layer

wherein the primer layer is positioned between the substrate and the constructional layer, and wherein the primer layer comprises a polymer and a wax. The invention also relates to methods for producing the layered assembly and methods for detaching the constructional layer from the layered assembly.

### STATE OF THE ART

In construction applications, it is common practice to attach various constructional layers, such as wall or floor covers, to cementitious substrates. Initially, the substrate is coated with a primer layer, which provides a flat and uniform surface, and a basis for effective bonding of the constructional layer. Such assemblies have high bonding strength between layers for maintaining high stability over long periods of time. Dismantling such an assembly would require high mechanical forces and specific tools or devices.

However, it can be desirable that the constructional layer can be purposively detached from the substrate, if required. For example, constructional layers are detached from cementitious substrates during renovation, replacement, repair or recycling. Due to the high bonding strength, detaching of such constructional layers is burdensome. High mechanical forces and specific tools devices must be applied, which requires high levels of energy, can result in dirt, dust and noise formation, and can be potentially dangerous for the user. Such procedures can also cause damage of the constructional layer or substrate, such that effective separation, re-use and recycling become difficult. These problems can incur high costs and render renovation and maintenance less efficient and burdensome.

It has been suggested in the art to provide layered assemblies with adhesive layers, which can be detached more easily under specific conditions. EP 3 002 387 A1 suggests a primer for coatings in constructional applications, for example for cementitious substrates. A cover layer is adhered to a substrate with a melt adhesive, whilst the cover layer can be detached with relatively low force. However, it is a problem that the bonding strength of such a detachable assembly is low under normal conditions. It is also suggested to support detachment by heating. However, the document does not disclose means or methods which would in fact reduce the bonding strength upon heating. Thus, it can be expected that the bonding strength is still relatively high upon heating. Besides, melt adhesives have various disadvantages. For example, they are relatively expensive, must be cured under heating, can only be processed for a short time period because of curing, and can be difficult to use on rough undergrounds. Thus, melt adhesives are not generally suitable as primer layers in construction applications.

In the technical field of adhesive polymers, methods are available for purposive detachment of adhesive layers from substrates. In these methods, an external trigger, such as UV-light or heat, induces degradation of the adhesive layer. In such procedures, functional groups in the three-dimensional polymer matrix undergo chemical reaction, such that the matrix is disintegrated. In some systems, detachment of the cover layer is supported by gas formation and expansion of the adhesive layer. An overview of degradable adhesive layers and methods is provided in Bandl et al., “Adhesives for debonding-on-demand: triggered release mechanisms and typical applications”, Int. J. of Adh. & Adh. 99, 2020, 102585. However, such degradable adhesive systems have various drawbacks. The chemical systems are relatively complicated and require complex and expensive polymers. The adhesives must be applied by specific procedures and cured, often under heating. Thus, they are normally designed for typical adhesive applications, such as adhering plastic parts in packaging or electronics. These systems are normally not applicable for providing stable permanent layered assemblies in construction applications with cementitious substrates.

EP 1 444 306 B1 discloses an adhesive composition comprising a polymer and crosslinker particles. The particles are inducible in an electromagnetic field and can mediate disintegration of the adhesive. The compositions can be used as varnishes or for adhesive applications, for example in airplane manufacturing. Construction applications or primer layers for cementitious substrates are not disclosed.

EP 1 921 118 A1 discloses a strippable floor coating composition for protecting and polishing floors. The floor coatings comprise several layers, including an undercoating agent based on a polymer and wax. Specific methods or mechanisms for detaching the strippable coating from the floor are not disclosed. Since the coated layer can be peeled off by hand, the bonding strength of the assembly under normal conditions is low. Construction applications, primer layers for cementitious substrates, or methods for stable and permanent attachment of constructional layers are not disclosed.

There is an ongoing need for layered assemblies and methods for construction applications, in which constructional layers are strongly and permanently bonded to cementitious substrates, but at the same time can be purposively detached in a convenient manner, if required.

### Problem Underlying the Invention

The problem underlying the present invention is to provide systems and methods which overcome the above-mentioned problems. Layered assemblies for construction applications shall be provided, in which constructional layers are bonded to substrates based on hydraulically binding compositions, in a stable and permanent manner with high bonding strength. On the other hand, the constructional layer shall be purposively detached from the substrate in a convenient manner, if required. The systems and methods shall be easily available and usable. Compositions and components for use in the system shall also be easily available and conveniently usable. The system shall be used and practiced by commercially available devices, chemicals and procedures, which are common in the technical field. The system shall be especially suitable for interior applications, in which it is especially important to provide systems which can be used easily and conveniently.

### DISCLOSURE OF THE INVENTION

Surprisingly, it was found that the problem underlying the invention is overcome by layered assemblies, methods and structural parts according to the claims. Further embodiments and aspects of the invention are outlined throughout the description.

Subject of the invention is a layered assembly comprising
(a) a substrate based on a hydraulically binding composition,
(b) a primer layer, and
(c) a constructional layer
   wherein the primer layer is positioned between the substrate and the constructional layer, wherein the primer layer comprises a polymer and a wax.

The layered assembly is for use in a constructional application, which is typically in the technical field of construction engineering or architecture. Construction applications include buildings, and especially interior applications, wherein cementitious structures and substrates are widely used. The layered assembly is especially advantageous in interior construction applications for which refurbishments occur more frequently, hence requiring a more frequent change of the constructional layer, particularly in commercially used buildings and structures. Preferred commercially used buildings and structures are selected from the group consisting of workplaces, the hospitality sector and sports facilities. Preferred workplaces are selected from the group consisting of workshops and offices.

Preferred buildings and structures in the hospitality sector are selected from the group consisting of restaurants, hotels and motels. However, also for the private customer or user the layered assembly according to the invention offers the advantage of having less dust, debris and dirt when conducting any refurbishments of a dwelling, particularly of a room, flat or building, and thus renders such refurbishments easier and more convenient to carry out.

The substrate, primer layer and constructional layer are attached to each other. The primer layer is positioned between the substrate and constructional layer. The layers form a stable and permanent assembly. In this context, the term “permanent” means that the assembly is configured for and remains intact during long-term use. However, the constructional layer can be purposively detached from the substrate, when heat is provided to the primer layer.

The heat can be provided either directly by heating with a heat source, or indirectly by applying an electrical current or electromagnetic field. Accordingly, the inventive layered assembly is different from conventional systems such as floor caring or polishing, wherein a coating layer is applied only temporarily, and bonded only weakly so that it can be peeled off more easily, particularly without using a device or tool, e.g. by hand.

The primer layer is attached directly to the substrate without an intermediate layer. The constructional layer is attached directly to the primer layer without an intermediate layer. In a preferred aspect of the invention, the layered assembly consists of the substrate, primer layer and constructional layer. In this aspect, the constructional layer forms the (outer) surface. The substrate can be provided on another part, layer, base, ground or support, such as a building foundation.

The primer layer comprises at least one polymer and at least one wax. The primer layer is formed by coating the substrate with a primer composition, which is preferably an aqueous emulsion or dispersion of the polymer and wax, and drying the primer composition. Upon drying, the primer composition becomes the solid primer layer. After drying, the constructional layer is applied onto the primer layer.

According to the invention, the primer layer is dried and solidified before the constructional layer is attached. However, the primer composition and primer layer are not cured, neither before nor after the constructional layer is applied. The primer layer is not hardened by chemical reaction, and no polymer matrix is formed in the primer layer. Instead, the polymer and wax form a thermoplastic layer. This is advantageous, because the primer layer can be softened and molten. Because of the wax component, the softening and melting temperature can be adjusted to relatively low levels. Preferably, the wax is provided in the primer composition in the form of an aqueous wax emulsion.

The primer layer has thermoplastic properties. Therefore, it can be softened and molten, such that the assembly can be disintegrated conveniently. The primer layer is not cured and/or the primer layer does not comprise a curing catalyst. According to the invention, the dried primer layer does not comprise a covalently bonded three-dimensional polymer matrix.

In this regard, the primer layer is different from a conventional adhesive layer. After combining all layers, adhesive layers in the art are cured in a process in which covalent bonds are formed between reactive groups throughout the adhesive layer, such that a three-dimensional matrix is formed. Further covalent bonds are also formed between the adhesive and adjacent layers. However, the high adhesive stability caused by the covalent bonds has the effect that conventional adhesive systems cannot be softened and disassembled conveniently at relatively low temperatures.

The primer layer may comprise 30 to 90 wt. % of wax, preferably 50 to 85 wt. % of wax, specifically 55 to 80 wt. % of wax, based on the total dry weight of the primer layer. Throughout this disclosure, percent values are in weight % (wt. %) or % by weight, unless explicitly stated otherwise, e.g. “% vol” or “vol %” which mean “percentage by volume”. Besides, weight percent and other parameters such as base weight or T_{g} relate to the dried primer layer and/or layered assembly, unless stated otherwise.

In a specific preferred aspect, the primer layer comprises at least 60 wt. % of wax, more preferably at least 65 wt. % of wax. It was found that such an amount of wax can be advantageous for detachment of the constructional layer after heating.

Waxes are non-polymeric, water insoluble organic compounds, which are lipophilic solids and are malleable around ambient temperature. Waxes include higher alkanes and lipids, typically with melting points above about 40° C. (104° F.), which form low viscosity liquids when molten. Natural waxes comprise functional groups, such as ester, carboxylic or alcohol groups.

The wax component is the main cause that the primer layer can be softened or molten by heating when the constructional layer is detached purposively. The ratio and amount of wax in the primer layer is adjusted so that the assembly can be dismantled conveniently. It is advantageous that the wax-based primer layer can be softened or molten at moderate temperature. Therefore, the energy which is required for dismantling the assembly is relatively low. Further, heat damage of components and layers can be avoided. In a specific aspect, the wax in the primer layer forms a matrix in which the polymer is distributed.

In a preferred aspect, the wax is selected from synthetic wax, such as paraffin wax and polyethylene wax; natural wax, such as carnauba wax or sugarcane wax; and modified wax, such as ester wax, amide wax or Fischer-Tropsch wax. Especially preferred are paraffin wax and carnauba wax. It was found that a primer layer which includes these waxes can have especially good properties regarding stability of the assembly at ambient temperature and dismantling upon heating.

Preferably, the primer layer has a softening temperature of between 60° C. and 120° C., as determined by Differential Scanning calorimetry (DSC). The softening temperature can be adjusted by selecting a wax component with a suitable drop point. Preferably, the drop point of the wax is between 60° C. and 150° C., or between 60° C. and 120° C., preferably between 60° C. and 100° C., as determined by ASTM D 3954. If the drop point of the wax is below 60° C., undesired softening of the primer layer and low stability of the assembly may occur during standard use. For example, temperatures of up to about 60° C. may already be reached upon exposure of the assembly to sunlight, in floor heating systems or in vicinity to electronic devices. On the other hand, if the drop point is above 120° C., the softening temperature of the primer layer would be too high and dismantling of the assembly would become difficult. The disassembly would then require too much energy and effort and could cause damage to other components and the environment. Such high temperatures are also undesirable in interior applications for user comfort and working place safety.

The wax can be provided in the primer composition for forming the primer layer in the form of a wax emulsion or dispersion. Suitable wax compositions are commercially available, for example carnauba wax from Deurex (X 5501 W) or Münzing (LUBA-print® CA 30 or 333/X), paraffin wax from Deurex (T 1601 W), Münzing (LUBA-print® 445/W or WÜLKONIL® AS 50), or mixed wax from Deurex (H 7308 W).

The primer layer may comprise 10 to 70 wt. % of polymer, preferably 15 to 50 wt. % of polymer, more preferably 20 to 45 wt. % of polymer, based on the total dry weight of the primer layer. When the amount of polymer is adjusted accordingly, it can advantageously be distributed in the primer layer to provide stability, but on the other hand the primer layer can be softened by heating and the constructional layer subsequently be detached.

In a specifically preferred aspect, the primer layer comprises at least 15 wt. % of polymer, preferably at least 20 wt. % of polymer. It was found that such an amount of polymer can be advantageous for strongly bonding the constructional layer to the substrate.

The primer layer may comprise 30 to 90 wt. % of wax and 5 to 40 wt. % of polymer, based on the total dry weight of the primer layer. In a preferred aspect, the primer layer comprises 50 to 85 wt. % of wax, and 15 to 50 wt. % of polymer, based on the total dry weight of the primer layer. In a more preferred aspect, the primer layer comprises 55 to 80 wt. % of wax, and 20 to 45 wt. % of polymer, based on the total dry weight of the primer layer. It was found that the stability of the assembly at ambient temperature and detachment upon heating can be especially effective if the components are adjusted accordingly. The combination of the polymer and wax component are adjusted so that high bonding strength of the primer layer to the specific substrate and constructional layer is obtained under standard conditions, whilst the constructional layer can be conveniently detached upon heating.

Preferably, the polymer is provided in the primer composition in the form of an aqueous polymer dispersion or emulsion. In a preferred aspect, the polymer is provided in the form of a polymer dispersion. Polymer dispersions comprise polymer particles dispersed in a liquid phase which is water. It was found that polymer dispersions can confer high stability to the primer layer. The polymer particles may be distributed in a wax matrix, which can be softened or molten upon heating.

In another preferred aspect, the polymer is provided in the form of a polymer emulsion. In an emulsion, the polymer chains which are normally water insoluble are distributed in an aqueous phase in the presence of an emulsifying agent. It was found that primer layers from polymer emulsions and wax can confer high stability to the layered assembly, which can be disintegrated conveniently upon heating.

Preferably, the primer composition is an emulsion or dispersion of the polymer and the wax. With such a primer composition, a uniform coating can be obtained in which the wax and the polymer are homogeneously dispersed. It was found that the homogeneous distribution can be preserved after drying. Accordingly, a uniform solid primer layer can be obtained throughout which the polymer and wax are finely distributed.

Preferably, the glass transition temperature (T_{g}) of the polymer is relatively low. In a preferred aspect, the T_{g} is between −50° C. and 30° C., preferably between −30° C. and 10° C. The T_{g} is a material property of the polymer, and thus not of the primer layer, which can be determined by Differential Scanning calorimetry (DSC). The relatively low T_{g} can be advantageous for forming a relatively stable primer layer and assembly. Polymers with relatively low T_{g} can have high tackiness and provide a strong bond between the primer layer, the substrate and the construction layer, such that the overall stability of the assembly is high. Further, when the T_{g} is low, the primer layer can have a certain degree of elastic properties around room temperature and may be capable of absorbing mechanical forces.

Various polymers can be used in the inventive primer layer. However, it was found that some polymers can confer especially advantageous properties to the primer layer and layered assembly. In a preferred aspect, the polymer is based on at least one monomer type selected from vinylacetate, ethylene, acrylate, acrylonitrile and styrol. In a preferred aspect, the polymer is acrylate-based or vinyl acetate-based. Preferably, the polymer is ethylene vinyl acetate copolymer (also known as ethylene-vinyl acetate or EVA) or polyacrylate. A polyacrylate (also known as acrylate polymer or acrylic) is a polymer prepared from acrylate monomers. Acrylates are salts, esters (such as methylacrylate) and conjugate bases of acrylic acid. The polyacrylate can be formed from acrylic monomers only or can be a copolymer prepared from acrylic monomers and other monomers. Typically, ethylene vinyl acetate copolymers (EVAs) or polyacrylate copolymers comprise relatively low amounts of other monomers for modifying the properties, for example less than 20 mol % or less than 10 mol %, based on all monomers in the polymer chain.

Preferably, the polymer is provided into the primer layer in the form of a polymer dispersion or emulsion. Especially preferred are aqueous dispersions or emulsions of ethylene vinyl acetate copolymer or polyacrylate. Polymer dispersions can have good workability in the production of a primer composition. Moreover, they can confer high stability to the primer layer, whilst the primer layer can be effectively softened upon heating. Suitable polymer dispersions of ethylene vinyl acetate copolymer or dispersions of polyacrylates are commercially available, for example under the trademark Acronal® A 380 from BASF, DE, or Vinnapas® EF 8860 or Vinnapas® EP 400 from Wacker, DE.

In a preferred aspect, the amount of primer layer in the assembly is 2 to 200 g/m², preferably 5 to 150 g/m². It was found that such a primer layer having such a basis weight can provide a stable assembly at ambient temperature and efficient disintegration upon heating. In this regard, the precise amount of primer layer can be adapted to the specific system or assembly. For example, the amount of primer composition should be sufficiently high that the substrate is covered completely with a flat and uniform surface, especially in the case of cementitious substrates having rough surfaces.

According to the invention, the polymer and/or the primer layer components are chemically stable, i.e. not chemically degraded, at the softening temperature and/or the melting temperature of the primer layer and/or at the temperature at which the layered assembly is dismantled. Preferably, the polymer and/or primer layer are chemically stable at 150° C., at 200° C. or even 250° C. Therefore, the layered assembly is different from adhesive “bonding-on-demand”-systems, which are disassembled at a temperature at which the adhesive layer is chemically decomposed. When the constructional layer is detached from the substrate according to the present invention, the primer layer is not substantially chemically degraded, there is no degradation of a polymer matrix, and no gas is formed. This is advantageous, because softening a thermoplastic layer is much simpler than adhesive “bonding-on-demand”-systems, does not lead to potentially harmful chemical reaction products, and allows softening at relatively low temperature.

The primer layer is based on the wax and polymer. However, the primer layer may comprise additives, which are not polymer or wax. As used herein, the term “additive” also does not include the electrically conductive and electromagnetically inducible components, if present. The additives are functional components, which confer desired properties to the primer layer or primer composition. For example, the additives can improve workability or stability of the primer composition.

In a preferred aspect, the primer layer substantially consists of the polymer, wax, and, if present, electrically conductive and electromagnetically inducible components. In this regard, the term “consists of” means that the total of these components is at least 95 wt. %, preferably at least 98% or at least 99%, based on the dry weight of the primer layer. Preferably, the amount of further additives is less than 10%, more preferably less than 5%, or less 2%, based on the dry weight of the primer layer. In a preferred aspect, the primer layer comprises at least one additive, selected from emulsifier, dispersant, defoaming agent and thickener.

In a preferred aspect, the composition comprises a defoaming agent. A defoaming agent can advantageously prevent foaming which can occur when processing and mixing wax emulsions and dispersions. For example, the defoaming agent can be a fat alcohol ethoxylate, a white oil defoamer (for example Foamaster® WO 2323™ from BASF, DE), or a silicon defoamer (such as SAG™ 240, from Momentive™). Preferably, the amount of defoaming agent is between 0.025% and 0.5%, more preferably between 0.025% and 0.1% by weight, based on the primer composition.

The detachment of the constructional layer from the substrate is supported by heat. The heat is provided to the layered assembly and/or the primer layer, such that the primer layer is softened or molten. Thereby, the bond between the substrate and constructional layer is weakened, and the constructional layer can be detached from the substrate.

In a preferred method, the assembly is heated from the surface, which can be the constructional layer. If sufficient heat is provided, the constructional layer is heated and in turn heats the primer layer. In other preferred aspects, the assembly comprises internal components for heating, such as conductive components or inducible components. Preferably, such internal components are positioned in the primer layer, in direct contact with the primer layer, and/or at least in vicinity to the primer layer. This is advantageous for efficient heat transfer to the primer layer for softening.

In one embodiment, the heat is provided by a heat source. In this embodiment, apart from the polymer and wax, no specific additives for generating heat are required in the primer layer. In an alternative embodiment, the primer layer or assembly comprise additives which can generate heat. For example, the primer layer or layered assembly may comprise at least one conductive component which can generate heat when an electrical current is applied, or at least one inducible component which can generate heat when an electromagnetic field is applied.

In a preferred aspect, the assembly comprises at least one conductive component. A conductive component is a component through which an electrical current can be applied. In view of the internal resistance of the conductive component, heat is generated when the electrical current flows. Preferably, the conductive component is embedded in the primer layer and/or positioned directly adjacent to the primer layer. Thereby, the heated conductive component can transfer the heat into the primer layer, thereby melting or softening the primer layer, such that the assembly can be disintegrated.

In a preferred aspect, the conductive component comprises a conductive structure, such as fibers, wires, strips, a mesh, grid or textile fabric. In another preferred aspect, the conductive component comprises conductive particles. Preferably, the conductive structure consists of or comprises metal or carbon. In these aspects, the overall primer layer is rendered conductive by the conductive component. An electrical current is applied through the primer layer by electrodes on different sides. The amount, type and position of the conductive component are adjusted such that desired conductivity and heating can be provided. If particles and/or short fibers are added, the density must be sufficient that they are contact each other.

In a preferred aspect, the conductive component comprises a combination of particles and fibers, preferably carbon particles and carbon fibers. Preferably, the carbon fibers are short fibers (staple fibers). Preferably, the carbon particles are carbon black particles, which can be provided in the form of a carbon black powder and/or dispersion. Especially preferred is a combination of short carbon fibers with carbon particles, preferably carbon black particles and/or carbon black dispersion. Especially preferred is a combination of carbon black particles, carbon black dispersion and short carbon fibers. Without being bound to theory, it is assumed that in such a mixture, the carbon short fibers are the main carrier of conductivity. If provided at sufficient level, short carbon fibers can contact adjacent fibers and provide a conductive matrix. The carbon particles can support conductivity by closing gaps between fibers. With a carbon black dispersion, relative high concentrations of carbon black can advantageously be integrated into the primer composition without impairing workability.

Preferably, the amount of conductive particles and fibers in the primer layer is from 1% to 30%, preferably from 2% to 25%. The amount is adjusted such that sufficient heat can be generated when an electrical current is applied for softening the primer layer. If the amount of the conductive component is too low, the layer cannot generate enough heat. If the amount of conductive component is too high, the internal stability of the primer layer can become too low, and preparation and coating of the primer composition can become difficult, for example because the viscosity is too high.

Preferably, the amount of carbon fibers in the primer layer is from 2% to 10% by weight, more preferably from 2.5% to 6% by weight of the primer layer. Preferably, the carbon fibers have a length between 0.2 mm and 5 mm, more preferably between 0.5 mm and 3 mm. If the carbon fibers would be too short, they could not provide sufficient conductivity. If the carbon fibers would be too long, it would be difficult to mix and process the primer composition. Preferred carbon fibers can be obtained from Schwarzwälder Textilwerke under trademarks SFC 0.2 MFC, SFC 0.5 EPB, SFC 1 EPB or SFC 3 EPB.

Preferably, the amount of carbon black powder is from 2% to 10%, more preferably from 3% to 8%, by weight percent of the primer layer. Suitable carbon black powders can be obtained from Orion Engineered Carbons, for example Printex® L type products. Preferably, the amount of carbon black dispersion is from 5% to 20%, more preferably from 7.5% to 15%, by weight percent of the primer composition. A preferred carbon black dispersion is obtainable under trademark PCI Elektroleit from PCI Augsburg GmbH, DE.

In a preferred aspect, the assembly comprises at least one inducible component. The inducible component can be induced electromagnetically. Electromagnetic or magnetic induction can generate heat from the inducible component in a changing magnetic field. The changing magnetic field is generated, for example, with a coil, particularly a solenoid, through which an (alternating) electrical current is applied. Typically, the electromagnetic field is provided from outside the layered assembly. Preferably, the electromagnetically inducible component is embedded in the primer layer and/or directly adjacent to the primer layer. By applying the external electromagnetic field, a desired amount of heat can be generated such that the primer layer is softened or molten. It is a specific advantage of electromagnetic induction that heat can be generated locally within the primer layer. Thus, electromagnetic induction does not require an external heat source. In a specific aspect, it can be used advantageously for procedures in which only a defined portion of a layered assembly is dismantled.

Inducible components for generating heat by electromagnetic induction are known in the art. In a preferred aspect, the inducible component comprises fibers, wires, strips, a foil, net, grid, mesh or textile fabric. Preferably, the inducible component consists of or comprises metal, such as iron, metal oxide and/or carbon. Especially preferred is an inducible metal, such as iron, for example in the form of metal fibers. A preferred inducible carbon is graphite.

Preferably, the amount of inducible components in the primer layer is from 1% to 30%, preferably from 2% to 25%. The amount is adjusted so that sufficient heat can be generated in an electromagnetic field for softening the primer layer. If the amount of the inducible component is too low, the layer cannot generate sufficient heat by induction. If the amount is too high, the internal stability of the primer layer can become too low.

Functional additives for stabilizing the conductive or inducible component in the primer composition can be used. For example, a thickener can be included into the primer composition, such that uniform distribution of the component is achieved.

According to the invention, different heating means can be combined, if desired. Thus, the method and assembly may comprise means for external heating of the primer layer, and/or for heating a conductive component by an electrical current, and/or for heating an inducible component by an electromagnetic field. For example, it may be advantageous to generate heat from a conductive component or inducible component, whilst at the same time supporting heating with an external heat source. Such a combination of heating means may be suitable especially for assemblies which are difficult to disintegrate, for example due to thickness, shape or accessibility.

The substrate is based on a hydraulically binding composition. Accordingly, at least the surface of the substrate, or a portion thereof, was obtained by providing and binding a hydraulically binding composition. Hydraulically binding compositions harden by setting in the presence of water. They are widely used as substrates in construction applications. Preferably, the substrate is concrete or screed. Preferably, the hydraulically binding composition is based on cement or calcium sulphate.

Preferably, the substrate is a cementitious substrate. Thus, it is prepared from cement. A cement (cementitious composition) is a binder used for construction that sets, hardens, and adheres to other materials to bind them together. Typically, cementitious compositions comprise fillers, such as sand and gravel, and additives, such as plasticizers, accelerators or retarders. The cement can be any known type, such as Portland cement. The substrate can be concrete. In the technical field of construction and building applications, rough cementitious substrates are often combined with functional constructional layers. Primer layers are used as intermediate layers for smoothening the substrate surface and increasing the bonding strength. According to the present invention, it was surprisingly found that a primer layer based on polymer and wax, which can be detached conveniently upon heating, can provide a strong bond between cementitious substrates and constructional layers, even if the cementitious substrate is uneven and rough. In the layered assembly, the primer layer is provided onto the surface of the substrate. The substrate typically comprises a flat surface. If the substrate comprises calcium sulphate, it is typically gypsum based (calcium sulphate dihydrate). Gypsum is formed from a mixture of anhydrous calcium sulphate and water.

A constructional layer is applied on the surface of the dried primer layer. As used herein, a constructional layer is a layer which is permanently attached to a substrate in construction applications, especially building applications. Preferably, the building application is an interior application. In interior applications, it is of special relevance that constructional layers can be detached conveniently, such that excessive heat, mechanical force, dust or debris are avoided. It is a prerequisite for permanent attachment that the constructional layer has relatively high bonding strength and tear resistance. Thus, a relatively high force is required for detaching the constructional layer from the substrate. Under normal conditions, the intact constructional layer cannot be detached by hand. The constructional layer cannot be peeled off or the like, such as a temporary protective layer which is used for example in floor polishing applications. In contrast, tools or devices are required for detaching the constructional layer, such as hammer and chisel.

In a preferred aspect, the constructional layer is a wall cover, floor cover, tile, plate, sheet, laminate, textile, carpet, or cementitious layer, such as a smoothing or self-levelling cementitious layer. In a preferred aspect, the constructional layer comprises a material selected from ceramic, glass, stone, plastic, textile, asphalt, plaster and concrete. The constructional layer may consist of such a single layer or material, or may comprise sub-layers, for example an adhesive layer or bonding layer. Many constructional materials do not have bonding ability, such as ceramic, glass or stone. They can be attached to the primer layer by a bonding layer, such as an adhesive layer or a hydraulically binding composition. For instance, constructional layers or sub-layers thereof may be provided as a precursor composition, which is dried or cured. A hydraulically binding composition, such as a cementitious layer, can be applied directly onto the primer layer. Conventional adhesives, such as epoxy, acrylic, silicone or polyurethane adhesives, or cementitious compositions can be used for attaching materials such as tiles, glass plates, stone plates, carpets or textile covers to the primer layer.

In a preferred aspect, the amount of the constructional layer in the assembly is at least 400 g/m², more preferably at least 800 g/m², or even at least 1,500 g/m². For example, the amount of the constructional layer can be from 400 g/m² to 4,000 g/m². The thickness of the constructional layer can be at least 1 mm, at least 2 mm or at least 4 mm. According to the invention, it was found that the primer layer based on polymer and wax can provide sufficient strength for attaching a relatively heavy constructional layer to the substrate.

As used herein, the layered assembly is not a furniture application or part thereof. Preferably, the constructional layer is not a cover or coating which is detachable at ambient temperature by low mechanical force or can be peeled off by hand, such as a wallpaper, or a protective polymer coating such as a floor polishing or floor care product. Preferably, the constructional layer has a minimum thickness of 0.5 mm.

In a preferred aspect, the bonding strength at room temperature between the substrate and constructional layer is at least 0.7 N/mm², more preferably at least 1.0 N/mm², even more preferably at least 1.5 N/mm². For example, the bonding strength can be determined by EN 13892-8. It was found that the primer layer based on the polymer and wax can provide such a high bonding strength to the layered assembly. This is advantageous, because the layered assembly is suitable for a wide range of construction and building applications.

When the primer layer is heated and softened, the constructional layer can be detached conveniently. Preferably, the constructional layer is then bonded only weakly or not at all, and can thus be removed by hand. Preferably, the bonding strength upon heating and softening is significantly lower than at room temperature, for example decreased by more than 50%, preferably by more than 80%, and more preferably by more than 90%. Preferably, the bonding strength upon heating and softening is less than 0.5 N/mm², more preferably less than 0.2 N/mm², most preferably about 0 N/m².

Typically, the primer layer covers the entire surface of the substrate. However, it is also conceivable that the primer layer is applied only on defined regions of the substrate. This could be advantageous if defined regions are to be provided in a layered assembly from which the constructional layer can be removed conveniently.

Subject of the invention is also a structural part comprising an assembly of the invention. The structural part is preferably a wall, floor, ceiling or part thereof.

Subject of the invention is also a method for preparing a layered assembly of the invention, comprising in consecutive order the steps of
(A) coating a substrate with a primer composition, which comprises a polymer and a wax,
(B) drying the primer composition to obtain the primer layer, and
(C) applying the constructional layer onto the primer layer.

The substrate in step (A) comprises a surface, which may be prepared by smoothening, cleaning and/or drying. The substrate is coated with the primer composition. The amount of the primer composition preferably is from 5 to 500 ml/m² of the primer composition and/or from 2 to 200 g/m² of solid components of the primer composition, based on the surface area of the substrate. More preferably the primer composition is in the form of an emulsion and the amount of the primer composition is from 5 to 500 ml/m² of emulsion and/or from 2 to 200 g/m² of solid components of the primer composition, based on the surface area of the substrate. Depending on the application and desired consistency, the primer composition can be provided in the form of a liquid or paste. The primer composition can be distributed and smoothened with conventional means. Depending on the consistency, it can be poured or grouted onto the substrate and spread with suitable tools, for example a trowel, roll or spatula.

The primer composition is prepared by combining and mixing the components. Preferably, a polymer dispersion or emulsion and a wax emulsion are used. With such dispersions and emulsions, homogenous mixing can generally be achieved conveniently. Mixing can be assisted by suitable devices, such as a dissolver and agitator.

The primer composition is an aqueous composition. Preferably, no other solvents such as alcohols are present. This is advantageous for environmental and cost reasons. When combining aqueous polymer and wax dispersions, it can be advantageous to adjust the viscosity with additional water.

When preparing a primer layer without a conductive and/or inducible component, all components can be mixed and stirred at relatively high speed until a homogenous composition is obtained. Such a primer composition can be poured onto the substrate in liquid form.

It can be advantageous to add conductive fibers and/or particles or inducible fibers after preparing a homogeneous mixture of the polymer, wax and other additives, preferably as the final component. When proceeding in this order, the conductive or inducible component can be distributed homogenously in the primer composition.

In a preferred method for preparing a conductive primer layer, all liquid components, including polymer and wax dispersions and emulsions, and additives are mixed initially together with a carbon black dispersion and defoaming agent. The composition is stirred at medium speed in a dissolver until homogeneous (at about 750 UpM). Carbon black powder can be added under slow stirring (such as 205 to 500 UpM). In a final step, conductive fibers can be added under rapid stirring (such as 1,500 UpM). Preferably, the components are adjusted such that a homogenous paste is obtained.

In case of inducible fibers, it is preferred to combine and mix all liquid components, including polymer and wax dispersions and emulsions, and additives until homogenous, preferably in a dissolver. The inducible fibers are added subsequently under slow stirring, followed by rapid stirring in order to disperse the inducible component homogenously. If relatively high amounts of inducible fibers are added, a paste is preferred.

Preferably, the primer composition comprises, based on the total weight of the primer composition
a) 11 to 40 wt. % of wax
b) 3 to 25 wt. % of polymer,
c) 0.1 to 5 wt. % of emulsifier,
d) optionally between 1 wt. % and 30 wt. % of conductive particles and/or fibers, or inducible fibers,
e) optionally up to 20 wt. % of further additives, and
f) 50 to 86.9 wt. % of water.

In step (B) of the method for preparing a layered assembly of the invention, the primer composition which has been coated onto the substrate is dried. Preferably, the primer composition is passively dried, for example by leaving it overnight. Alternatively, the drying can be supported by an air flow and/or limited heating below the temperature for softening the wax, for example with a fan or heated fan. After drying, the solid primer layer is obtained, which comprises no or only negligible residual water.

In a preferred aspect, the coating in step (A) and drying in step (B) are carried out at ambient temperature, i.e. without heating (or cooling). Typically, ambient temperature at a construction site is between 5° C. and 40° C., preferably between 10° C. and 30° C. Thus, the assembly can be prepared in a relatively simple and energy-efficient manner.

In step (C), the constructional layer is applied onto the dried primer layer. For example, a cementitious composition can be coated onto the primer layer and dried. Alternatively, constructional parts such as tiles or carpets can be attached to the primer layer, for example with a cementitious composition or an adhesive.

If desired, a conductive or inductive structure, such as conductive wires or an inductive net, can be integrated when the layered assembly is formed. In a preferred aspect, the parts are positioned on the substrate before step (A). Subsequently, the parts are covered with the primer composition in step (A) and become embedded in the primer layer. Also electrical devices and parts thereof, such as electrodes and sensors, can be integrated into the primer layer accordingly.

Subject of the invention is also a method for detaching the constructional layer from a layered assembly of the invention, comprising
(i) heating the assembly until the primer layer softens or melts, and
(ii) removing the constructional layer from the substrate.

In step (i) heat is supplied in an amount sufficient to soften or melt the primer layer. Preferably, the primer layer is heated to a temperature between 60° C. and 120° C. Softening and melting is predominantly caused by the wax component, which has a significantly lower melting point than the polymer. An external heating source can be used, or internal heat can be generated in case of conductive or inductive components. These mechanisms can also be combined. In step (ii), the constructional layer is removed from the substrate when the primer layer is softened or molten.

Surprisingly, it was found that heating step (i) can decrease the bonding strength between the substrate and constructional layer irreversibly, such that the bonding strength remains low even after subsequent cooling. Consequently, it is not required to remove the constructional layer immediately or rapidly after heating. This is advantageous in that there is no time pressure after heating the assembly in step (i). The user can heat the entire assembly before removing the constructional layer, and even take a break between steps (i) and (ii), for example overnight. Overall, the method for detaching the constructional layer is relatively easy and convenient. This is advantageous for professional, DIY or individual users, for example during renovation or recycling.

Without being bound to theory, the irreversible loss of bonding strength may be observed, because the uniform internal structure of the solid primer layer can be disintegrated upon heating. This has the effect that the polymer and wax are segregated. As a result, the wax can accumulate in a sublayer, which has low affinity to the other layers and hence destabilizes the assembly.

In a preferred aspect, the assembly is heated by an external heat source. In this aspect, it is not required that the primer layer or assembly comprises a conductive or inductive component. The amount of heat and position of the heat source are adjusted such that the layered assembly or a part thereof receives enough heat for softening or melting the primer layer or a region thereof. Preferably, the heat source is a radiant heater. The heat source can be moved over the surface of the constructional layer until enough heat for softening or melting of the primer layer has been provided. The primer layer becomes a separation layer thereby, which has the lowest binding force and is destroyed when the constructional layer is detached. Preferably, the form of the constructional layer or parts thereof, such as tiles, is maintained upon detachment. Preferably, no residues of the constructional layer remain attached to the substrate. Accordingly, the substrate and/or constructional layer or parts thereof, are obtained in their original state, and are thus suitable for further use. This is highly advantageous for applications such as renovation and recycling. Preferably, the constructional layer can be removed by hand, i.e. without a tool or specific devices.

In a preferred aspect, the assembly comprises a conductive component and is heated by applying an electrical current. The electrical current can be provided by electrodes attached to or integrated into the assembly. Preferably, the electrodes are embedded in the assembly, especially in the primer layer. The electrical current flows through the conductive component positioned in or adjacent to the primer layer and generates internal heat for softening or melting the primer layer. Typically, the amount of heat generated depends on the internal electrical resistance of the conductive component.

At a laboratory scale, softening of the primer layer could be achieved with electrodes at a distance of about 20 cm, preferably 20 cm, and an electrical resistance of between 3Ω and 20Ω at a voltage of 30 V (direct current). In practice, in order to achieve sufficient softening of the primer layer and when a higher voltage such as about 230 V is used, the electrodes can be at a distance of from about 20 cm to about 3 m, preferably of from about 0.5 m to about 2 m, more preferably of from about 0.5 m to about 1 m. In practice, in order to achieve sufficient softening of the primer layer and when a higher voltage such as about 230 V is used, it is aimed for an electrical current in the range of from about 2 A to about 8 A at an electrical resistance of the primer layer of from about 28 (to about 115Ω, preferably aimed for an electrical current in the range of from about 2 A to about 6 A at an electrical resistance of the primer layer of from about 38Ω to about 115Ω, preferably aimed for an electrical current in the range of from about 4 A to about 6 A at an electrical resistance of the primer layer of from about 38Ω to about 58Ω. The electrical resistance of the primer layer can frequently be in the range of from 30Ω to 120Ω, when applying a voltage of about 230 V and an electrical (direct) current of from about 2 A to about 8 A. A conventional cementitious constructional layer could be removed by hand when a temperature of more than 65° C. is reached. The bonding strength of the constructional layer could be reduced from between 0.65 and 0.73 N/mm² to about 0 N/mm² when raising the temperature from room temperature to 65° C.

The term “electrically conductive” or “electrically conductive component” characterizes or refers to a material that heats up by an electrical current going through it and caused by an applied voltage typically available in a building or on a construction site, such as from about 30 V to about 400 V, particularly from about 230 V to about 400 V or from 230 V to about 380 V, more particularly of about 230 V. A suitable material in this sense may for instance be selected from the group consisting of metal and carbon and its modifications. The metal may particularly be selected from the group consisting of iron, steel, copper and aluminium, preferably the group consisting of steel, copper and aluminium. Steel may particularly be selected from the group consisting of structural steel, more particularly be the structural steel variant (steel grade) ST37 (corresponding to SR235JR or 1.0037). Carbon may particularly be selected from the group consisting of soot, graphite, carbon fibers and graphene, preferably be selected from the group consisting of soot, graphite and carbon fibers, more preferably be selected from the group consisting of graphite and carbon fibers.

Most preferably the carbon modification is graphite. Thus, a suitable electrically conductive component or material may also be selected from the group consisting of iron, steel, copper, aluminium, carbon and its modifications. A suitable electrically conductive component or material may further also be selected from the group consisting of structural steel, copper, aluminium, and the carbon modifications soot, graphite, carbon fibers and graphene.

In a preferred aspect, the assembly comprises an inducible component and is heated by applying an electromagnetic field. For example, an induction heating device can be used, such as IHG 1500™ from Unicraft. The inducible component in the primer layer can be heated to the desired temperature. The constructional layer can be removed conveniently from the assembly if a temperature such as about 65° C. for softening the wax is reached. The use of inducible components can be advantageous in various applications, since neither electronic parts such as electrodes nor external heating means are required.

The term “electromagnetically inducible” or “electromagnetically inducible component” characterizes or refers to material which is electrically conductive, for instance metallic, (whereby it may be diamagnetic), or it exhibits an enhanced—compared to diamagnetism—interaction with a magnetic field, and which is particularly ferromagnetic, ferrimagnetic, paramagnetic or superparamagnetic. A suitable electromagnetically inducible component or material in this sense may be selected from the group consisting of diamagnetic, ferromagnetic, ferrimagnetic, paramagnetic and superparamagnetic materials. A suitable electromagnetically inducible component or material may also be selected from the group consisting of diamagnetic, ferromagnetic, ferrimagnetic and paramagnetic materials. The ferromagnetic material may be selected from the group consisting of iron, steel and metal oxides of the ferrite type, preferably be selected from the group consisting of steel and metal oxides of the ferrite type. Steel may particularly be selected from the group consisting of structural steel, more particularly be the structural steel variant (steel grade) ST37 (corresponding to SR235JR or 1.0037). The diamagnetic material may be selected from the group consisting of copper and carbon and its modifications. Carbon may particularly be selected from the group consisting of soot, graphite, carbon fibers and graphene, preferably be selected from the group consisting of soot, graphite and carbon fibers, more preferably be selected from the group consisting of graphite and carbon fibers. Most preferably the carbon modification is graphite. The diamagnetic material may be selected from the group consisting of copper (magnetic susceptibility of about −5.46*10⁻⁶ cgs) and graphite (magnetic susceptibility of about −6.0*10⁻⁶ cgs). The paramagnetic material may be aluminium (magnetic susceptibility of about 16.5*10⁻⁶ cgs).

A suitable electromagnetically inducible component or material may also be selected from the group consisting of iron, steel, metal oxides of the ferrite type, copper, soot, graphite, carbon fibers, graphene and aluminium, preferably be selected from the group consisting of steel, metal oxides of the ferrite type, copper, soot, graphite, carbon fibers, graphene and aluminium.

The term “about” according to the invention means a variation of the parameter value concerned from ±0.5% to ±10%, preferably from ±0.5% to ±5%, more preferably from ±1% to ±5%.

Exemplified embodiments of the invention and aspects of the invention are shown in the figures.

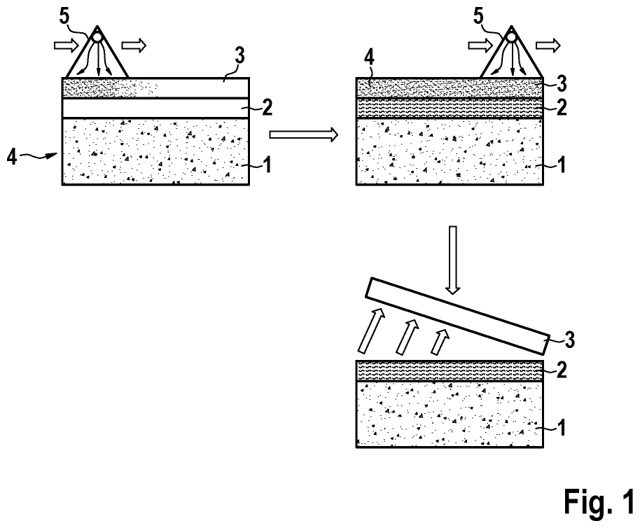

FIG. 1 shows schematically and in exemplified form a layered assembly of the present invention and method for detaching the constructional layer by heating the assembly with an external heat source.

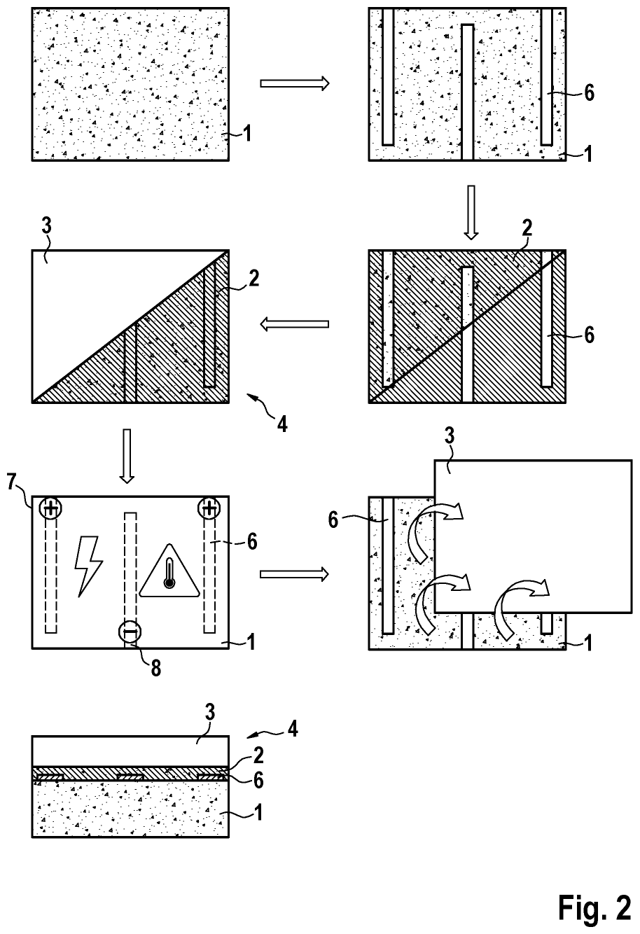

FIG. 2 shows schematically and in exemplified form a layered assembly of the invention comprising a conductive component and method for detaching the constructional layer by applying an electrical current.

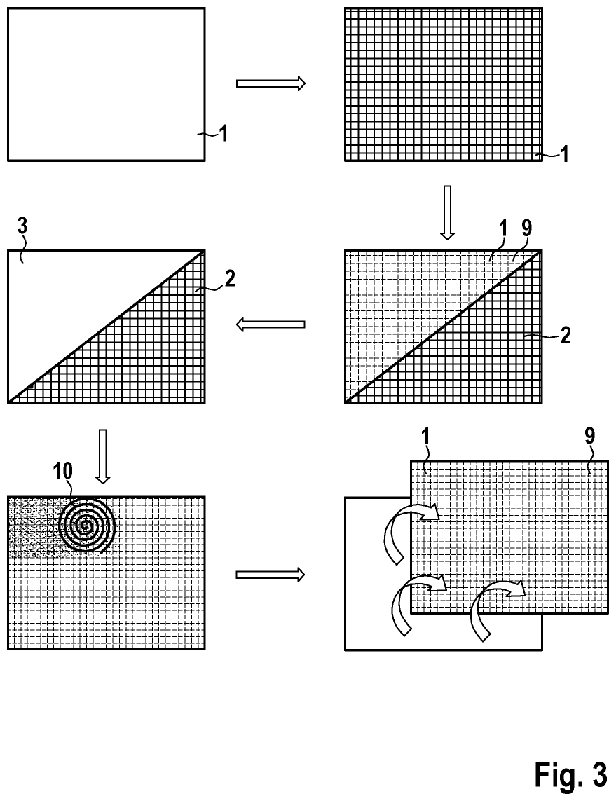

FIG. 3 shows schematically and in exemplified form a layered assembly of the invention with an inducible component, which is an inducible mat, and a method for detaching the constructional layer by applying an electromagnetic field.

FIGS. 1 to 3 show layered assemblies and methods for detaching the constructional layer from the substrate after heating in exemplified form. Each layered assembly 4 consists of substrate 1, primer layer 2 and constructional layer 3. The substrate can be a concrete slab.

When heat is provided or generated, the primer layer comprising the polymer and wax is softened or molten and the constructional layer is detached.

FIG. 1 shows an aspect in which primer layer 2 is heated by external heat source 5, which is moved over the surface of constructional layer 3. In this aspect, the primer layer 2 does not comprise a conductive or inducible component. After softening the primer layer, the constructional layer can be detached.

FIG. 2 shows a layered assembly 4 in which the primer layer comprises a conductive component in the form of copper wires 6. The copper wires 6 are laid in parallel on the surface of concrete slab 1. The primer layer 2 is coated on concrete slab 1 such that the copper wires 6 are embedded in the primer layer 2 (only half the primer layer is shown for better understanding). Constructional layer 3 is applied on the surface of primer layer 2 and a stable layered assembly 4 is obtained. For purposive detachment of constructional layer 3, a voltage is applied through copper wires 6 by electrodes 7, 8. The inherent electrical resistance of the copper wires 6 has the effect that primer layer 2 is heated. After softening of the primer layer 2, constructional layer 3 can be detached from substrate 1.

FIG. 3 shows an alternative aspect of a layered assembly with an inducible net 9 embedded in primer layer 2. In this aspect, voltage is applied through coil 10 which causes electromagnetic induction of the inducible net 9. The induction has the effect that the inducible net 9 is heated and primer layer 3 is softened. The coil 10 can be moved over the surface of constructional layer 3 to provide enough heat across the entire area. After softening of primer layer 2, the constructional layer 3 can be detached from substrate 1.

The layered assembly and methods solve the problem underlying the invention. A comparatively simple and efficient system is provided for stable attachment of constructional layers to cementitious substrates, which can be used for a wide range of construction and building applications. On the other hand, the constructional layer can be purposively detached at a desired time in a simple and convenient manner, for example when the layered assembly is refurbished or renovated, recycled, repaired or changed. The detachment of the constructional layer can be carried out precisely and requires only low amounts of energy. If the system is adjusted appropriately, the constructional layer can be removed by hand, and thus without exerting strong mechanical force or using special devices. The system and method according to the invention are user-friendly, and any undesirable generation of dust, debris, noise, heat, damage and/or working hazards can be avoided.

### EXAMPLES

Layered assemblies were produced with various primer layers. The mechanical stability at room temperature and release upon heating were evaluated as outlined in the following.

### Production of Primer Compositions

Primer compositions were prepared from polymer and wax dispersions or emulsions as summarized below. The defoaming agent used was SAG™ 240 (Momentive silicon oil emulsion defoamer, density 1.0039 g/cm³). To the wax emulsion, the polymer emulsion or dispersion, defoaming agent and water were added. The components were mixed in a dissolver at a rotational speed of 500 to 1,000 UpM.

| | Type | Trade mark, supplier |
|---|---|---|
| P1 | acrylic emulsion polymer solids | Ucar ™ Latex DL 435, |
| | content 49%; T_{g} 0° C. | DOW Chemical |
| P2 | acrylic ester copolymer dispersion | Acronal ® A 380, BASF |
| | solids content 62%; T_{g} −22° C. | AG |
| P3 | acrylic emulsion polymer solids | Primal ™ CA 172, |
| | content 60.5%-61.5%; T_{g} −21° C. | DOW Chemical |
| W1 | paraffin combination wax dispersion | LUBA-print ® 280W, |
| | solids content 50%; drop point 82° C. | Münzing |
| W2 | ester wax dispersion solids | LUBA-print ® KL 30, |
| | content 30%; melting point 72-80° C. | Münzing |

### Production of Layered Assemblies

Layered assemblies were produced from the substrate, primer compositions as outlined above, and a cementitious constructional layer. The substrate was a concrete slab (paving slab) with the dimensions 29.7×40×4.5 cm, which is commercially available from Mosaicos Solana. Each cleaned and dried substrate slab was coated with 5 to 6 g (corresponding to 42 to 50 g/m²) of the primer composition. The substrate with the coated primer composition was left standing until the primer layer became solid and completely dry. A 5 mm margin was adhered around each primer layer-coated substrate slab with PTW Fixband (5×10 mm). The constructional layer was a floor cover prepared from a cementitious composition of trademark Thomsit DX (PCI Augsburg GmbH). The cementitious composition was initially suspended with 260 g water per kg solid. The cementitious composition was poured onto the surface of the primer layer in an amount of 900 to 1000 g per slab and left standing until hardening and setting was completed.

### Properties of Layered Assemblies

The layered assemblies prepared as outlined above were tested for stability at 22° C. and release of the constructional layer upon heating. The heating temperature at which the layered assemblies were dismantled was set to 65° C.

The stability of each layered assembly was determined in a rating test at room temperature and when the primer layer was heated. Grades from 1 (very good) to 6 (deficient) were defined for adhesion at 22° C. and release upon heating as outlined in the following:

| Grade | Adhesion at 22° C. | Release upon heating |
|---|---|---|
| 1 | can only be removed by using tools (A); | falls off by itself or can be |
| very good | adhesion comparable to conventional | removed by hand (nearly no |
| | polymer-based primers or better | adhesion) |
| 2 | can be removed by using tools (B); | can easily be removed by using a |
| good | adhesion still comparable to conventional | painter's spatula or more |
| | polymer-based primers | difficultly by hand |
| 3 | can be removed by using tools (C); | can be removed with low to |
| satisfactory | adhesion significantly lower than with | medium force by using a |
| | conventional polymer-based primers | painter's spatula |
| 4 | can be removed with low to medium force | can be removed by using tools |
| sufficient | by using a painter's spatula | (C) |
| 5 | can easily be removed by using a painter's | can be removed by using tools |
| poor | spatula or more difficult by hand | (B) |
| 6 | falls off by itself or can be removed by hand | can only be removed by using |
| deficient | (nearly no adhesion) | tools (A) |

Level of Strength Needed when Using Tools:

(A)=heavy force when using hammer and chisel

(B)=medium force when using hammer and chisel

(C)=low force when using hammer and chisel

The results are summarized in Table 1. The results show that the layered assembly of the invention is highly stable at room temperature. On the other hand, the bonding strength can be reduced at elevated temperature and the constructional layer can be purposively detached in a convenient manner at elevated temperature. The assembly can be optimized for a specific substrate and constructional layer by varying the wax to polymer ratio and types.

TABLE 1
Primer compositions and results

| | 1 | 2 | 3 | 4 | 5 |
|---|---|---|---|---|---|
| Primer composition | | | | | |
| polymer type | P1 | P2 | P3 | P3 | P1 |
| wax type | W1 | W2 | W3 | W3 | W2 |
| polymer [% vol] | 23.33 | 17.33 | 17.33 | 23.33 | 10.00 |
| wax [% vol] | 46.62 | 52.62 | 52.62 | 46.62 | 59.95 |
| Defoamer [% vol] | 0.05 | 0.05 | 0.05 | 0.05 | 0.05 |
| Water [% vol] | 30 | 30 | 30 | 30 | 30 |
| polymer [% wt.] solids | 32.8 | 40.4 | 27.7 | 37.9 | 21.4 |
| wax [% wt.] solids | 67.2 | 59.6 | 71.3 | 62.1 | 78.2 |
| Results primer layer | | | | | |
| level adhesion at 22° C. | 2 | 2-3 | 3 | 2 | 4 |
| level release after heating | 3-4 | 3 | 3 | 5 | 1-2 |

The results demonstrate that the layered assembly provides advantageous properties for layered assemblies based on cementitious substrates in building applications, which are on the one hand highly stable, but on the other hand can be dismantled conveniently if desired.

1. A layered assembly comprising
(a) a substrate based on a hydraulically binding composition,
(b) a primer layer, and
(c) a constructional layer
wherein the primer layer is positioned between the substrate and the constructional layer, and wherein the primer layer comprises a polymer and a wax.

2. The assembly of claim 1, wherein the primer layer comprises from 50 to 85 wt. % of wax and from 15 to 50 wt. % of polymer, based on the total weight of the primer layer.

3. The assembly of claim 1, wherein the T_{g} of the polymer is between −50° C. and 30° C., preferably between 30° C. and 10° C.

4. The assembly of claim 1, wherein the polymer is based on at least one monomer type selected from the group consisting of vinyl acetate, ethylene, acrylate, acrylonitrile and styrol.

5. The assembly of claim 1, wherein the polymer is ethylene vinyl acetate copolymer or polyacrylate.

6. The assembly of claim 1, wherein the wax is a synthetic wax, natural wax, and/or modified wax.

7. The assembly of claim 1, wherein the primer layer is not cured and/or wherein the primer layer does not comprise a curing catalyst.

8. The assembly of claim 1, which comprises at least one electrically conductive component.

9. The assembly according to claim 8, wherein the electrically conductive component comprises fibers, wires, strips, a mesh, grid or textile fabric and/or particles wherein the electrically conductive component comprises carbon particles and/or carbon fibers.

10. The assembly of claim 1, which comprises at least one electromagnetically inducible component.

11. The assembly according to claim 10, wherein the electromagnetically inducible component comprises fibers, wires, strips, a foil, net, grid, mesh or textile fabric, wherein the electromagnetically inducible component consists of or comprises metal metal oxide, or carbon.

12. The assembly of claim 1, wherein the primer layer comprises at least one additive, selected from the group consisting of emulsifier, dispersant, defoaming agent and thickener.

13. The assembly of claim 1, wherein the substrate is concrete or screed and/or wherein the hydraulically binding composition is based on cement or calcium sulphate.

14. The assembly of claim 1, wherein the constructional layer is a wall cover, floor cover, tile, plate, sheet, laminate, textile, carpet or cementitious layer, and/or
wherein the constructional layer comprises a material selected from the group consisting of ceramic, glass, stone, plastic, textile, asphalt, plaster and concrete, and/or
wherein the basis weight of the constructional layer is at least 400 g/m².

15. The assembly of claim 1, wherein the bonding strength between the constructional layer and the substrate at 25° C. is at least 0.7 N/mm².

16. A structural part comprising an assembly of claim 1, wherein the structural part is preferably a wall, floor, ceiling or part thereof.

17. A method for preparing a layered assembly according claim 1, comprising in consecutive order the steps of
(A) coating a substrate with a primer composition, which comprises a polymer and a wax,
(B) drying the primer composition to obtain the primer layer, and
(C) applying the constructional layer onto the primer layer.

18. The method of claim 17, wherein the substrate is coated with the primer composition in an amount of from 5 to 500 ml/m² of the primer composition and/or of from 2 to 200 g/m² of solid components of the primer composition.

19. A method for detaching the constructional layer from a layered assembly of claim 1, comprising
(i) heating the assembly until the primer layer softens or melts, and
(ii) removing the constructional layer from the substrate.

20. The method according to claim 19, wherein the primer layer is heated to a temperature of between 60° C. and 120° C.

21. The method according to claim 19, wherein the assembly comprises an electrically conductive component and is heated by applying an electrical current, and/or
wherein the assembly comprises an electromagnetically inducible component and is heated by applying an electromagnetic field.
